(19) United States
(12) Patent Application Publication
(10) Pub. No.: US 2003/0057715 A1
(43) Pub. Date: Mar. 27, 2003

(54) Electromagnetic lock

(76) Inventors: Daniel Salomon Brami, Boulogne Billancourt (FR); Isaac El Mechali, Pantin (FR); Jean Michel Defert, Sannois (FR)

Correspondence Address: GREENBLUM & BERNSTEIN, P.L.C., 1950 ROLAND CLARKE PLACE, RESTON, VA, 20191, US

(21) Appl. No.: 10/239,197

(22) PCT Filed: Feb. 13, 2001
(86) PCT No.: PCT/FR01/00404

(30) Foreign Application Priority Data
Mar. 30, 2000 (FR) 00 04004

(51) Int. Cl. E05C 3/06

(52) U.S. Cl. 292/201

(57) ABSTRACT

The invention concerns an electromagnetic lock comprising two parts (1 and 2), one of consists of an electromagnet and the other comprising a mobile armature (3) capable of moving to counter the return springs when the electromagnet is energized. The invention is characterized in that one of the parts has at least one protuberance (6), extending from one edge (7) of the corresponding part to the proximity of the other edge (8), capable of penetrating into a housing (9) of the other part when said parts coincide and the electromagnet is energized, the height of said protuberance being less than the distance normally separating the two parts when the electromagnet is not energized.

The present invention relates to an electromagnetic lock. Such a lock comprises two parts, one of which is fixed while the other is affixed to the element for which one would like to control the closing, such as a door.

The fixed part of the lock consists of an electromagnet and the other part of a metal armature capable of being displaced to counter a return spring. When the armature is facing the electromagnet and the latter is energized, said armature is attracted and it is not possible to control the door as the force needed for pulling the armature away is much greater than the force that could be provided by an average user.

Currently, these locks are arranged such that their active surfaces are parallel to the areas of the opening to be controlled. As a result, the necessary force to be applied in order to allow the sliding of the armature with respect to the electromagnet is much less than the aforementioned one (pulling force).

It is possible to overcome this drawback by increasing the force of the electromagnet, but such an increase translates into an unacceptable increase of the volume of said electromagnet and its cost.

An adequate solution to avoid an oversizing of the electromagnet consists of providing, on one of the parts of the lock, a protuberance capable of penetrating into a housing of the other part and of maintaining itself therein as long as the electromagnet is energized.

Such a lock is described, among others, in the document WO 99/188315 and comprises a mobile armature having two truncated, diagonally opposed, protuberances capable of penetrating into corresponding housings of the electromagnet when said armature is facing the latter. Since the height of the aforementioned protuberances is greater than the distance that normally separates the electromagnet and the armature, the latter is floatingly mounted on its base, which involves the use of two series of opposing springs that keep the armature balanced. Such a lock is expensive because of the use of two springs. Furthermore, the adjustment of the two springs is difficult.

The lock of the invention, which overcomes these drawbacks, is characterized by the use of a common armature comprising a return spring that keeps said armature and the electromagnet spaced apart when said electromagnet is not energized, and in that one of the elements of the lock comprises at least one linear protuberance extending parallel to the direction of displacement of the mobile part capable of penetrating into a corresponding housing, provided on the other part, when said two parts coincide, the height of said protuberance being less than the distance separating the latter when the electromagnet is not energized.

The present invention will be better understood from the following description, with reference to the attached drawings given only by way of example, and in which.

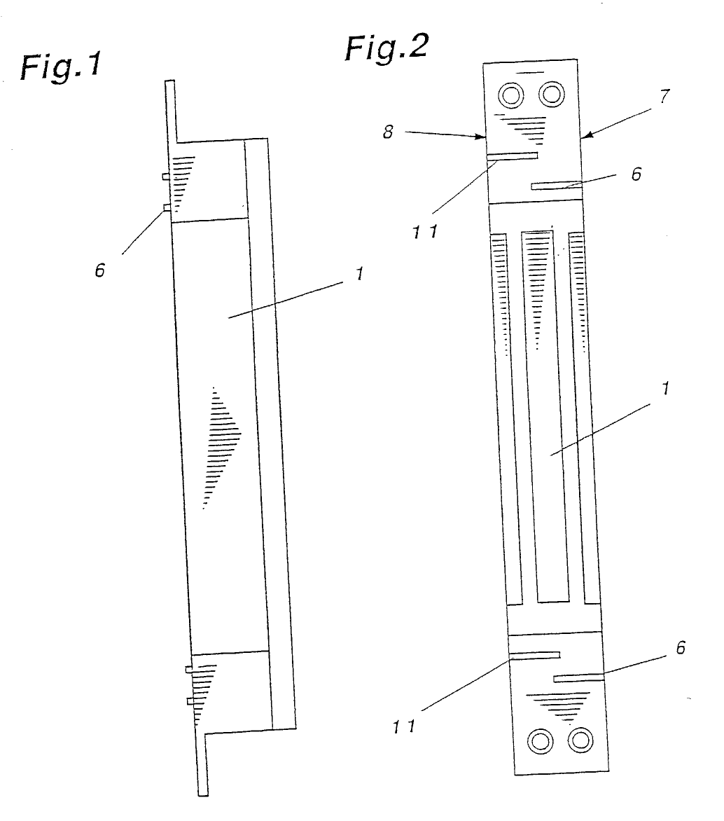

FIG. 1 is a front view of one of the parts of the lock;

FIG. 2 is the left view of FIG. 1;

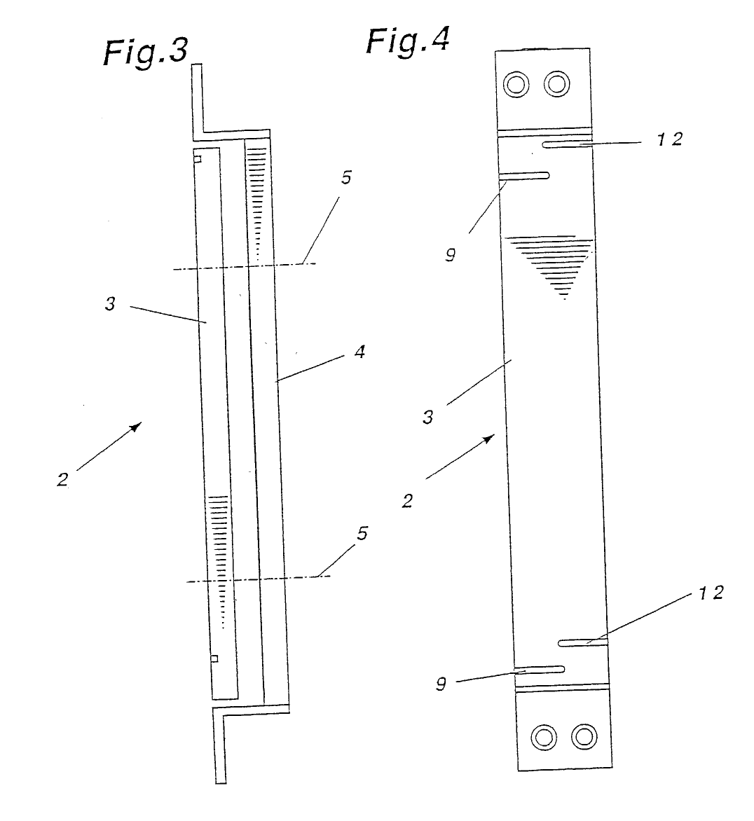

FIG. 3 is a front view of the other part of the lock;

FIG. 4 is the left view of FIG. 3;

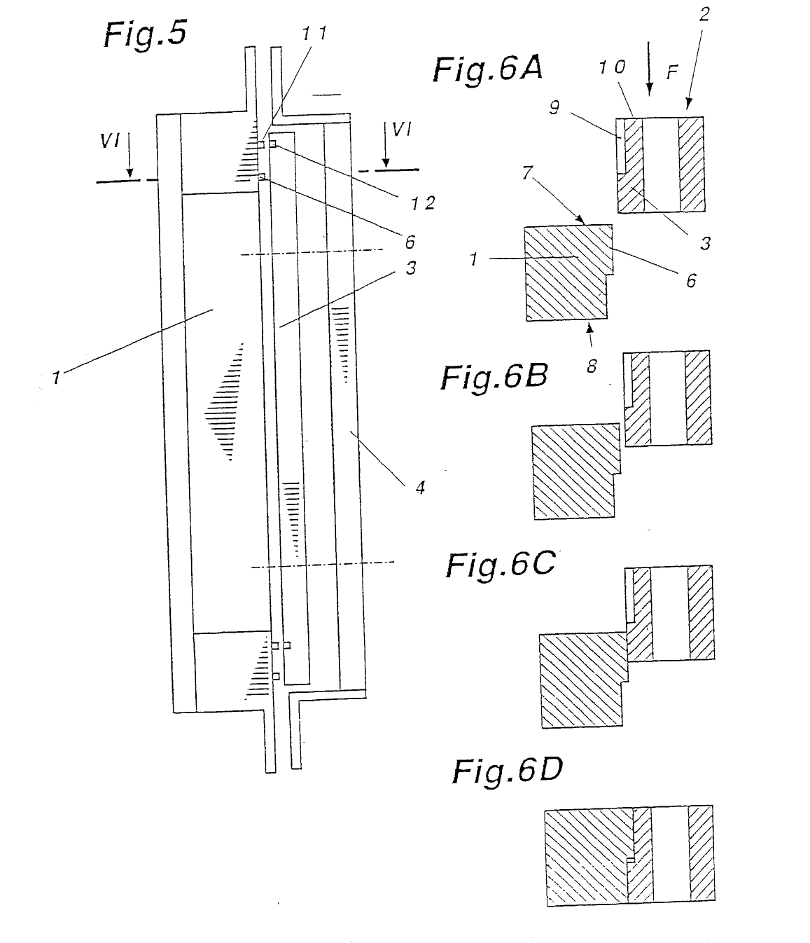

FIG. 5 is a front view of a lock according to the invention, the electromagnet is not energized;

FIGS. 6A, 6B, 6C and 6D are cross-sectional views taken along the line VI-VI of FIG. 5.

In referring to the drawings and as known, one can see that the lock is composed of two parts 1 and 2, the part 1 comprising the electromagnet and the part 2 comprising the mobile armature 3 which is normally returned to the stationary base 4 by means of two identical springs whose axes are shown by the reference number 5 in FIG. 3.

According to the invention, the part 1 has at least one protuberance 6 that is in the form of a rod extending transversely to said part and along a direction parallel to the direction of displacement of the other part, if the part 1 is considered as being stationary. The protuberance 6 must extend parallel to the plane containing the direction of displacement.

The protuberance 6 extends from one edge 7 to the proximity of the other edge 8 of the part 1, and its height is less than the distance separating the two parts 1 and 2 when the electromagnet is not energized, as seen in FIG. 5.

The armature 3 has, on its front surface, at least one housing 9 opening out on its edge 10 and capable of coinciding with the protuberance 6 when the two parts of the lock are facing each other.

Hereinafter, we will assume that the part 1 is affixed to the door frame of the opening and that the part 2 is affixed to the door.

At the end of closing (FIG. 6A), the part 2 is displaced substantially along the arrow F and the electromagnet is energized. The part 2 passes without difficulty from the position shown in FIG. 6A to the one shown in FIG. 6B since the common springs for returning the armature are calibrated such that the action of the electromagnet has no effect on the armature 4 as long as the latter does not have a certain surface facing, said electromagnet.

As the part 2 continues to move along the arrow F, the force of the electromagnet becomes greater than that of the return springs, the armature 4 is displaced transversely and takes support against the protuberance 6 (FIG. 6C) on which it slides until the moment when, the housing 9 coming opposite the protuberance 6, it executes a new transverse displacement to occupy the position shown in FIG. 6D.

As long as the electromagnet is energized, a displacement in the opposite direction from the arrow F is impossible.

In the case of swinging doors, it is necessary to prevent the displacement of the door in the direction of the arrow F as well as in the opposite direction.

According to the invention, this result is obtained by providing a protuberance 11 on the part 1, similar to the protuberance 6 but extending from the edge 8 to the proximity of the edge 7, capable of cooperating with a housing 12 similar to the housing 9.

Preferably, a pair of protuberances 6-11 is provided at both ends of the part 1.

1. Electromagnetic lock comprising two parts (1 and 2), one of which is constituted of an electromagnet and the other comprises a mobile armature capable of being displaced to counter the return springs when the electromagnet is energized, characterized in that one of the parts has at least one protuberance (6) extending from one edge of the corresponding part to the proximity of the other edge, capable of penetrating into a housing (9) of the other part when said parts coincide and when the electromagnet is energized, the height of said protuberance being less than the distance normally separating said two parts when the electromagnet is not energized.

2. Lock according to claim 1, characterized in that the return springs are set such that the force that tends to displace the armature (3) is greater than the force of said springs only when the surface of the armature facing said electromagnet exceeds a certain value.

3. Lock according to any of claims 1 and 2, characterized in that one of the parts has at least a second protuberance (11), similar to the first but from the other edge of said part, capable of cooperating with a housing (12) similar to the first (9).
